(19) United States
(12) Patent Application Publication
(10) Pub. No.: US 2025/0369763 A1
(43) Pub. Date: Dec. 4, 2025

(54) SYSTEMS AND METHODS FOR OPTIMIZING ENERGY CONSUMPTION ON A ROAD TRIP

(71) Applicant: Ford Global Technologies, LLC, Dearborn, MI (US)

(72) Inventors: Dominique Meroux, Ann Arbor, MI (US); Chen Zhang, South Lyon, MI (US); Hyongju Park, Ann Arbor, MI (US); Ruoxi Wen, Indianapolis, IN (US)

(73) Assignee: Ford Global Technologies, LLC, Dearborn, MI (US)

(21) Appl. No.: 18/677,450

(22) Filed: May 29, 2024

(51) Int. Cl. G01C 21/34; B60H 1/00; B60L 58/24; B60N 2/56; F24F 11/63; G01C 21/36

(52) U.S. Cl. CPC G01C 21/3469; B60H 1/0073; B60L 58/24; B60N 2/5678; G01C 21/3423; G01C 21/3679; F24F 11/63

(57) ABSTRACT

A road trip planning system including a transceiver and a processor is disclosed. The transceiver may be configured to receive trip information associated with a user. The trip information may include information associated with a trip source location and a trip destination location. The processor may determine that the user may be traveling via a vehicle between the trip source and destination locations. The processor may further monitor a real-time vehicle geolocation when the vehicle may be traveling between the trip source and destination locations, and predict an estimated time of arrival for the user at the trip destination location based on the real-time vehicle geolocation. The processor may further transmit information associated with the estimated time of arrival to a computing device associated with the trip destination location. The computing device may activate user comfort devices at the trip destination location based on user's estimated time of arrival.

### FIELD

The present disclosure relates to systems and methods for optimizing energy consumption on a road trip for electric vehicles (EVs).

### BACKGROUND

Electric Vehicles (EVs) may be charged at EV charging stations. If a user is traveling on a long trip, the user may require to charge the user's EV multiple times. In some instances, such as during peak hours, electric energy pricing associated with the energy to charge an EV may be higher than other times. If the user charges the EV frequently during such time durations, it may result in inconvenience to the user.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a first example scenario of a user traveling between a trip source location and a trip destination location in accordance with the present disclosure.

FIG. 2 depicts a second example scenario of a user traveling between a trip source location and a trip destination location in accordance with the present disclosure.

FIG. 3 depicts a flow diagram of an example first road trip planning method in accordance with the present disclosure.

FIG. 4 depicts a flow diagram of an example second road trip planning method in accordance with the present disclosure.

### DETAILED DESCRIPTION

### Overview

The present disclosure describes a road trip planning system (“system”) that may be configured to optimize energy consumption and/or reduce emissions on a trip that a user may be undertaking. The system may be configured to obtain trip information from the user and determine whether a train and a carshare vehicle (e.g., a carshare Electric Vehicle (EV)) may be available to transport the user from a trip source location to a trip destination location. Responsive to determining that the train and the carshare EV are available, the system may transmit a request to the user to avail the train and the carshare EV for the trip, as opposed to using user's own personal vehicle (which may also be an EV).

In some aspects, when the user may be traveling on a long trip, a train and EV carshare combination may be a faster option for the user and more convenient, as the user may be required to make fewer charging stops (as opposed to using personal vehicle for the entire trip). Further, per-passenger efficiency of the train (especially if the train is electric) may be more than driving own vehicle. This is because using the train causes reduced energy consumption, reduced grid strain, and reduced emissions. Further, the EV carshare vehicle then permits flexibility for the user to travel the rest of the trip. Therefore, in most cases, the combined train and carshare EV trip option reduces the total travel time and charging stops, and helps in maximizing the trip's total energy efficiency.

Responsive to the user declining the request from the system or responsive to determining that the train and/or the carshare EV are not available, the system may determine that the user may be traveling by the user's personal vehicle along the entire distance between the trip source location and the trip destination location. Responsive to such determination, the system may first cause the user's personal vehicle to pre-condition itself a predefined time duration before a user's planned departure time from the trip source location.

The system may further determine one or more optimal charging stations along the trip route at which the user may charge the user's personal vehicle and an optimal amount of energy the user may transfer to the vehicle at each of the determined optimal charging stations. In some aspects, the system may determine the optimal charging stations and the optimal amount of energy such that a user's spend on the energy is optimized, while at the same time ensuring that the emissions due to vehicle charging are minimal. In an exemplary aspect, the system may determine the optimal charging stations and the optimal amount of energy based on charging station information associated with a plurality of charging stations located between the trip source and destination locations, vehicle information and trip information.

In some aspects, the charging station information may include information associated with an expected emission rate associated with each charging station for different times of a day, an expected per unit energy price at each charging station for different times of a day, wear and tear information associated with one or more components of each charging station, an energy output capacity information associated with each charger of each charging station, and/or the like. Further, the vehicle information may include an energy receiving capacity information associated with the vehicle, a wear and tear information associated with one or more components of the vehicle, and/or the like.

Responsive to determining the optimal charging stations and the optimal amount of energy, the system may transmit information associated with the determined charging stations and the amount of energy to the vehicle and the charging stations, so that the vehicle may be optimally charged. The system may further monitor a real-time vehicle geolocation as the vehicle travels on the trip and may predict an estimated arrival time at the trip destination location for the user based on the real-time vehicle geolocation. Responsive to predicting the estimated arrival time, the system may transmit information associated with the estimated arrival time to a computing device associated with the trip destination location, which may control operation of one or more user comfort devices at the trip destination location based on the estimated arrival time. For example, if the trip destination location is a hotel, the computing device may switch ON a heating, ventilation, and air conditioning (HVAC) system of a hotel room booked for the user a predefined time duration before the estimated arrival time (and may not keep the HVAC system switched ON throughout the day), thereby conserving energy at the hotel.

In further aspects, when the user accepts the system's request to avail the train and the carshare EV for the trip, the system may reserve a sitting area for the user at the train and the carshare EV. The system may further perform the same actions for the carshare EV as described above in the context of user's personal vehicle to optimize the user's spend on energy and reduce emissions on the trip.

The present disclosure discloses a road trip planning system that enables a user to optimize spend on energy required for vehicle charging, when the user may be traveling on a long trip. The system further enables the user to assist in reducing emissions. The system recommends the user to travel by efficiency-maximizing transport options, which may be, e.g., a train, an autocar, a carpool, and/or the like.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

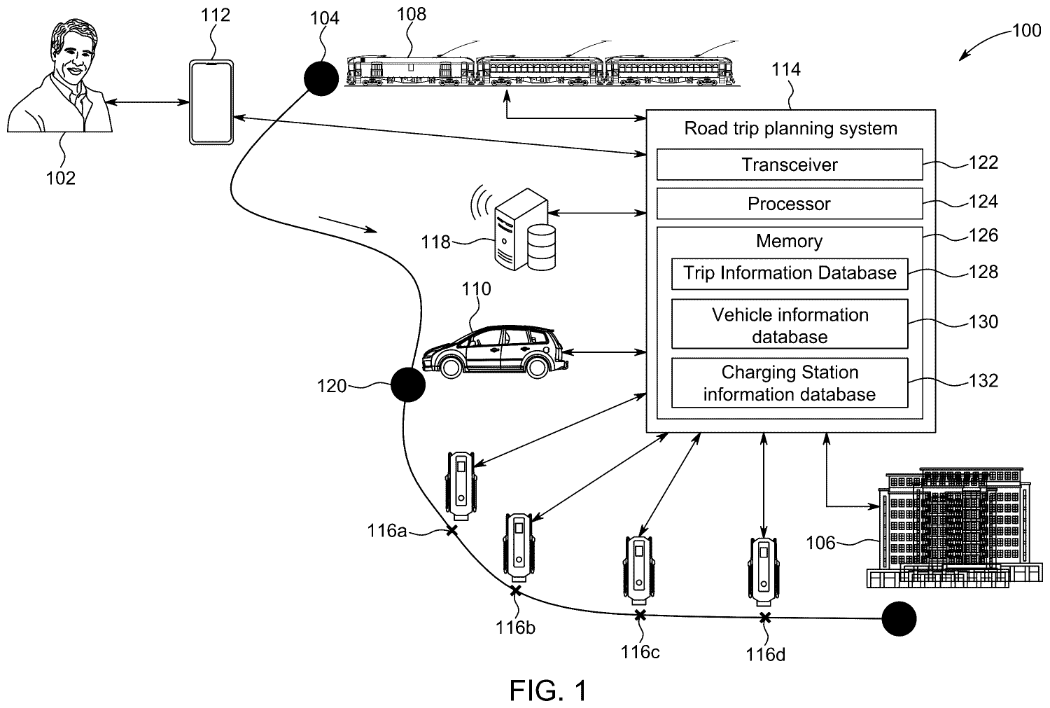

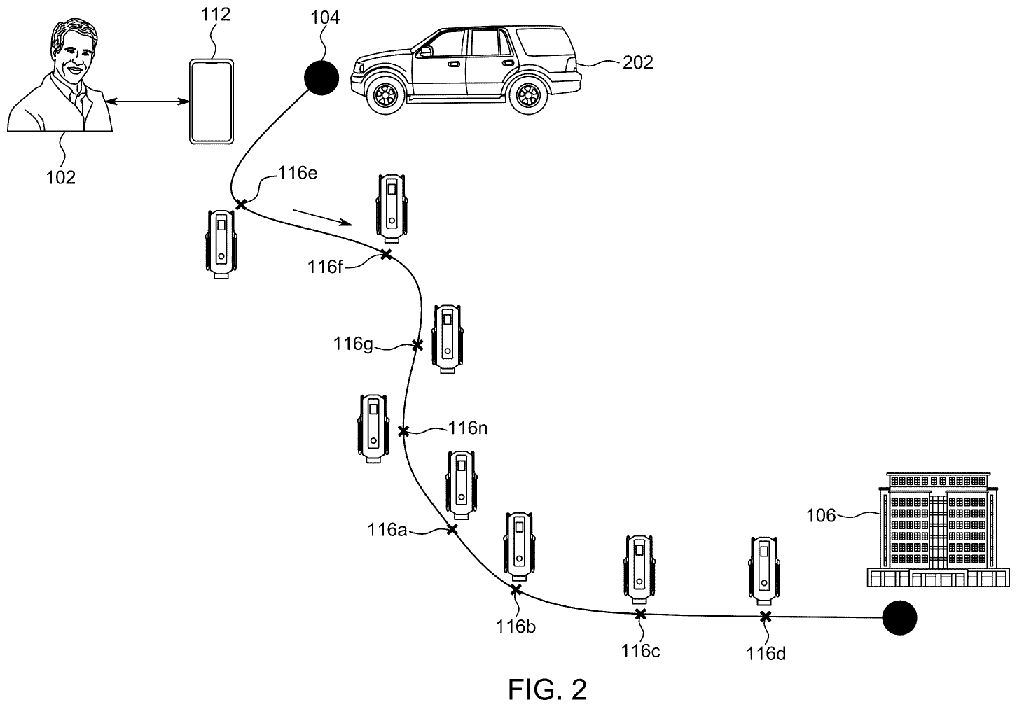

FIG. 1 depicts a first example scenario 100 of a user 102 traveling between a trip source location 104 and a trip destination location 106 in accordance with the present disclosure. FIG. 1 will be described in conjunction with FIG. 2, which depicts a second example scenario 200 of the user 102 traveling between the trip source location 104 and the trip destination location 106.

In an exemplary aspect, the trip source location 104 may be user's house and the trip destination location 106 may be a hotel, and the trip that the user 102 undertakes may be a long trip (i.e., a distance between the trip source location 104 and the trip destination location 106 may be substantial, e.g., more than 200 or 300 miles). In other aspects, the trip may be a short trip, and the trip source location 104 may be different from the user's house and the trip destination location 106 may be different from a hotel.

In one exemplary aspect, the user 102 may travel the entire distance between the trip source location 104 and the trip destination location 106 by using user's own vehicle 202 (e.g., a first vehicle), as shown in FIG. 2. In another exemplary aspect, the user 102 may travel a portion (or a trip portion) of the distance between the trip source location 104 and the trip destination location 106 by using a train 108 or any other efficiency-maximizing transport option (e.g., a second vehicle) and the remaining distance (or remaining trip portion) by using another vehicle 110 (e.g., a third vehicle), as shown in FIG. 1.

The vehicles 202, 110 may take the form of any passenger or commercial vehicle such as a car, a work vehicle, a crossover vehicle, a truck, a van, a minivan, a taxi, a bus, etc. The vehicles 202, 110 may be a manually driven vehicle or may be configured to operate in a partially/fully autonomous mode. In an exemplary aspect, the vehicle 202 may be a bi-directional Electric Vehicle (EV). A bi-directional EV, as described herein the present disclosure, may mean a vehicle that may be configured to obtain electric energy from a charging station during vehicle charging operation and also transfer energy from a vehicle energy storage (e.g., a vehicle battery, not shown) back to the charging station or to the grid/another vehicle/equipment during vehicle discharging operation. Stated another way, electric energy flows from the grid to the vehicle 202 via the charging station during the vehicle charging operation, and electric energy flows from the vehicle 202 (specifically from the vehicle's battery) to the grid or another vehicle/equipment during the vehicle discharging operation. In other aspects, the vehicle 202 may not be a bi-directional EV.

Further, in some aspects, the vehicle 110 may be a carshare EV that the user 102 may rent/book to travel between fixed locations on the trip. In other aspects, the vehicle 110 may be an E-transit van, an E-bike, an E-scooter, and/or the like. In yet another aspect, the vehicle 110 may be same as the vehicle 202. In this case, the user 102 may use user's personal vehicle (e.g., the vehicle 202) to travel on specific portions of the trip and may travel the remaining distance by using the train 108.

The user 102 may use or be associated with a user device 112, which may be, for example, a mobile phone, a laptop, a computer, a smartwatch, or any other device with communication capacities. The user device 112 may be communicatively coupled with a road trip planning system 114 (or system 114) via a wireless network (not shown). The wireless network, as described herein, illustrates an example communication infrastructure in which the connected devices discussed in various embodiments of this disclosure may communicate. The wireless network may be and/or include the Internet, a private network, public network or other configuration that operates using any one or more known communication protocols such as transmission control protocol/Internet protocol (TCP/IP), Bluetooth®, Bluetooth® Low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The system 114 may be configured to plan and assist in the implementation of the trip for the user 102, such that energy consumption during the user's trip may be optimized and emission and/or user's spend on energy pricing may be reduced. The system 114 may be communicatively coupled (e.g., via the wireless network described above) with a plurality of systems/devices/units including, but not limited to, the user device 112, the vehicles 110, 202, the train 108, computing systems (not shown) associated with a plurality of charging stations 116a, 116b, 116c, 116d, 116c, 116f, 116g, 116n (and/or chargers, collectively referred to as charging stations 116, as shown in FIGS. 1 and 2) located between the trip source location 104 and the trip destination location 104, a computing device associated with the trip destination location 104 (e.g., a hotel computing device), one or more servers 118 (or server 118), and/or the like.

In some aspects, the server 118 may be configured to determine and store train information, which may include, for example, information associated with travel times/schedule of the train 108 between the trip source location 104 (or any other location in the trip) and an intermediary trip location 120 (which may be a train station), a real-time train geolocation or running status, a ticket availability and reservation status associated with the train 108, and/or the like. The server 118 may transmit the train information to the system 114 at a predefined frequency, or when the system 114 transmits a request to the server 118 to obtain the train information.

In further aspects, the server 118 may be configured to determine and store a vehicle 110 information, which may include, for example, a ticket availability and reservation status associated with the vehicle 110, energy receiving capacity information associated with the vehicle 110, a wear and tear information associated with one or more components of the vehicle 110, and/or the like. The server 118 may transmit the vehicle 110 information to the system 114 at a predefined frequency, or when the system 114 transmits a request to the server 118 to obtain the vehicle 110 information. In some aspects, the system 114 may also directly obtain the vehicle 110 information from the vehicle 110.

In additional aspects, the server 118 may be configured to determine and store a charging station information, which may include, for example, an expected emission rate associated with each charging station 116 for different times of a day, week, etc. (including current and forecasted marginal grid CO2 emissions), an expected per unit energy price at each charging station 116 for different times of a day, week, etc. (taking into account utility pricing structure), wear and tear information associated with one or more components (e.g., chargers, batteries, charging cords, etc.) of each charging station 116, or an energy output capacity information associated with each charger of each charging station 116, a grid strain level/status at each charging station location, and/or the like. A person ordinarily skilled in the art may appreciate that the expected emission rate associated with each charging station 116 may vary depending on whether the charging station 116 is operating off-grid or 100% on renewable energy, or using a micro-grid or virtual power plant (VPP) including an on-site battery energy storage and renewable power generation system, or operating on grid power. Further, the expected emission rate and/or the energy output capacity information may incorporate parameters such as energy loss during transfer from the charger to the vehicles 110, 202 (or other vehicles), battery energy storage degradation, charging station energy consumption (e.g., energy consumed to illuminate large display screens for advertising, etc.), implementation of one or more renewable energy programs/policies by the charging station 116, and/or the like.

The server 118 may transmit the charging station information to the system 114 at a predefined frequency, or when the system 114 transmits a request to the server 118 to obtain the charging station information. In some aspects, the system 114 may additionally obtain some part of the charging station information directly from the charging stations 116.

In some aspects, the system 114 may be part of the vehicle 202, the server 118 or any other server or distributed computing system. The system 114, regardless of whether it is part of the vehicle 202, the server 118 or any other server or distributed computing system, may include a plurality of units/components including, but not limited to, a transceiver 122, a processor 124 and a memory 126, which may be communicatively coupled with each other. The transceiver 122 may be configured to transmit/receive information/data to/from external systems and devices via the wireless network described above. For example, the transceiver 122 may be configured to receive the train information, the vehicle 110 information, the charging station information, and/or the like from the server 118 via the wireless network. The transceiver 122 may be further configured to receive a trip information from the user 102 via the user device 112 and/or the server 118. The trip information may include, for example, information associated with the trip source location 104, the trip destination location 106, a user's planned departure time from the trip source location 104, a user's planned or desired arrival time at the trip destination location 106, and/or the like.

The transceiver 122 may be further configured to transmit signals/information/data to the server 118, the vehicles 110, 202, the computing device associated with the trip destination location 106, the chargers associated with the plurality of charging stations 116, the user device 112, and/or the like.

The processor 124 may be in communication with one or more memory devices in communication with the respective computing systems (e.g., the memory 126 and/or one or more external databases not shown in FIG. 1). The processor 124 may utilize the memory 126 to store programs in code and/or to store data for performing aspects in accordance with the disclosure. The memory 126 may be a non-transitory computer-readable storage medium or memory storing a program code that enables the processor 124 to perform operations in accordance with the present disclosure. The memory 126 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

The memory 126 may include a plurality of databases including, but not limited to, a trip information database 128, a vehicle information database 130, a charging station information database 132, and/or the like. The trip information database 128 may store the trip information that the system 114 receives from the user device 112 and/or the server 118. The charging station information database 132 may store that the charging station information that the system 114 receives from the server 118 and/or the charging station 116. The vehicle information database 130 may store the vehicle 110 information that the system 114 receives from the server 118 or directly from the vehicle 110 and the train information that the system 114 receives from the server 118. The vehicle information database 130 may be further configured to store a vehicle 202 information, which may be similar to the vehicle 110 information and may include information associated with an energy receiving capacity information associated with the vehicle 202, a wear and tear information associated with one or more components of the vehicle 202, and/or the like. The system 114 may receive the vehicle 202 information directly from the vehicle 202.

In operation, the user 102 may transmit, directly via the user device 112 or via the server 118 or the vehicle 202, the trip information to the system 114/transceiver 122 when the user 102 desires to travel from the trip source location 104 to the trip destination location 106. The processor 124 may obtain the trip information from the transceiver 122 and may then formulate/plan a trip energy optimization strategy for the user's trip. Specifically, responsive to obtaining the trip information, the processor 124 may obtain the train information and the vehicle 110 information from the vehicle information database 130 and determine whether the train 108 and the vehicle 110 are available to transport the user 102 from the trip source location 104 to the trip destination location 106 according to the user's planned departure time from the trip source location 104 and the user's planned or desired arrival time at the trip destination location 106. More specifically, the processor 124 may determine whether the train 108 is available to transport the user 102 from the trip source location 104 at the user's planned departure time to the intermediary trip location 120, the vehicle 110 is available at an estimated train's arrival time at the intermediary trip location 120, and the vehicle 110 will be able to transport the user 102 from the intermediary trip location 120 to the trip destination location 104 at the user's planned or desired arrival time.

Responsive to determining that the train 108 and the vehicle 110 are available to (and able to) transport the user 102 from the trip source location 104 to the trip destination location 106 according to the user's planned departure and arrival times as described above, the processor 124 may transmit, via the transceiver 122, a request to the user device 112 (or the vehicle 202) requesting the user 102 to travel the trip by using the train 108 and the vehicle 110, thus conserving energy consumption in the trip. A person ordinarily skilled in the art may appreciate that by traveling a trip portion via the train 108 (as opposed to using the personal EV 202), the user 102 may help in conserving energy that may be required to power the personal EV associated with the user 102 (e.g., the vehicle 202) and also help in reducing emissions that may be emitted during frequent vehicle 202 charging events. Traveling the trip portion by the train 108 may also facilitate the user 102 in conserving resources/pricing spent on energy during the charging events.

The user 102 may view/hear the request on the user device 112 (or the vehicle 202) and may decline the request on the user device 112 (or the vehicle 202) if the user 102 does not desire to travel by the train 108 and the vehicle 110 and may instead desire to travel by the user's own vehicle 202. In this case, the processor 124 may obtain, via the transceiver 122, a user decline signal or user inputs from the user device 112 (or the vehicle 202) when the user 102 declines the request. Responsive to obtaining the user decline signal or the user inputs from the user device 112 (or the vehicle 202), the processor 124 may determine that the user 102 is traveling (or desires to travel) the entire distance between the trip source location 104 and the trip destination location 106 by the vehicle 202 (i.e., the scenario 200 shown in FIG. 2).

In further aspects, the processor 124 may determine that the user 102 is traveling (or may have to travel) the entire distance between the trip source location 104 and the trip destination location 106 by the vehicle 202, when the processor 124 determines that the train 108 and/or the vehicle 110 are not available to (or not able to) transport the user 102 from the trip source location 104 to the trip destination location 106 according to the user's planned departure and arrival times. In this case, the processor 124 may not transmit the request to the user device 112 (or the vehicle 202) described above and may instead directly perform the steps described below.

Responsive to determining that the user 102 is traveling (or desires to travel) the entire distance between the trip source location 104 and the trip destination location 106 by the vehicle 202, the processor 124 may transmit, via the transceiver 122, a command signal to the vehicle 202 to cause a vehicle 202 pre-conditioning a predefined time duration before the user's planned departure time from the trip source location 104. The vehicle 202 may pre-condition itself, responsive to receiving the command signal from the processor 124. In some aspect, the vehicle 202 pre-conditioning may include controlling a vehicle 202 battery temperature, a vehicle 202 cabin temperature, a vehicle 202 steering wheel temperature, a vehicle 202 sitting area temperature, and/or the like so that the vehicle 202 is “ready” to provide comfort to the user 102 at the user's planned departure time, while at the same time ensuring that the vehicle 202 is not unnecessarily cooled or heated much before the user's planned departure time (thereby conserving energy consumption by the vehicle 202). Pre-conditioning the vehicle 202 also ensures that the vehicle 202 battery is at an optimal temperature, at which the vehicle charging efficiency may be high.

When the user 102 commences the trip from the trip source location 104, the processor 124 may begin to obtain, e.g., via the server 118 or directly from the vehicle 202, a real-time vehicle 202 geolocation. The processor 124 may further monitor the real-time vehicle 202 geolocation as the vehicle 202 travels between the trip source location 104 and the trip destination location 106.

The processor 124 may further obtain the charging station information and the vehicle 202 information from respective databases of the memory 126 when or before the vehicle 202 may be traveling on the trip. The processor 124 may then determine one or more optimal charging stations, from the plurality of charging stations 116, at which the vehicle 202 may charge during the trip, based on the charging station information, the vehicle 202 information, the user's planned departure time from the trip source location 104, the user's planned or desired arrival time at the trip destination location 106, and the real-time vehicle 202 geolocation.

In some aspects, the processor 124 may determine the optimal charging stations such that the emission rate and/or per-unit energy pricing during the vehicle charging operation may be low. As an example, the processor 124 may estimate expected times when the vehicle 202 may pass through each charging station 116 on the trip and may determine one or more specific charging stations (e.g., the charging stations 116g, 116b) for the vehicle 202 to charge at which the vehicle 202 may pass during those times of the day when the energy demand from the grid to the charging station (or the expected emission rate) may be low and/or the per-unit energy pricing may be low. As another example, the processor 124 may determine those charging stations for the vehicle 202 that may operate on renewable energy, thus facilitating in reducing emission rate. As yet another example, the processor 124 may determine those charging stations for the vehicle 202 that may have fast DC chargers, so that the vehicle 202 may get quickly charged.

In some aspects, while determining the optimal charging stations (e.g., the charging stations 116g, 116b) for the vehicle 202 to charge on the trip, the processor 124 may factor-in the user's planned or desired arrival time at the trip destination location 106, demand/traffic/waiting times at each charging station 116, energy output capacity associated with each charger at each charging station 116, energy receiving capacity associated with the vehicle 202 (e.g., how long it takes to transfer different amounts of energy to the vehicle 202), and/or the like so that the user 102 reaches the trip destination location 106 at the user's planned or desired arrival time (and the travel is not delayed). The processor 124 may also factor-in wear and tear information associated with batteries or other components at the charging stations 116 and/or the vehicle 202, which may affect vehicle's energy receiving capacity and/or charger/charging station's energy output capacity, while determining the optimal charging stations (e.g., the charging stations 116g, 116b) for the vehicle 202 to charge. In further aspects, the processor 124 may also factor-in local pollution levels at each charging stations 116 and may identify those charging stations as optimal charging stations for the vehicle 202 to charge, which may a higher level of toxic pollutants in air. A person ordinarily skilled in the art may appreciate that if an EV, e.g., the vehicle 202, travels through such areas of high toxic pollutants (as opposed to an Internal Combustion Engine (ICE) vehicle), the vehicle 202 may help reduce the release of exhaust in air.

Responsive to determining the charging stations 116g, 116b as the optimal charging stations for the vehicle 202 to charge during the trip as described above, the processor 124 may transmit, via the transceiver 122, a location information associated with the charging stations 116b, 116g to the vehicle 202 and/or the user device 112, so that the user 102 may stop and charge at the charging stations 116b, 116g when the vehicle 202 passes through these stations. In this manner, the processor 124 facilitates in assisting the vehicle 202 to charge at those charging stations that may have lower per-unit energy pricing and may help in reducing emissions and/or release of pollutants in air in areas with high pollution levels.

In addition to sharing the location information to the vehicle 202 and/or the user device 112 as described above, the processor 124 may transmit, via the transceiver 122, the real-time vehicle 202 geolocation and/or an estimated time of arrival at the charging stations 116b, 116g to computing systems associated with the charging stations 116b, 116g. The computing systems may use the real-time vehicle 202 geolocation and/or the estimated time of arrival to optimize consumption of energy at the charging stations 116b, 116g. For example, the computing systems may reserve a charger for the vehicle 202 according to the real-time vehicle 202 geolocation and/or the estimated time of arrival and may control the operating conditions of the reserved charger (and/or other charging station components) based on the real-time vehicle 202 geolocation and/or the estimated time of arrival. In an exemplary aspect, the computing systems may keep the display screen of the reserved charger in dark-mode or dim-mode or in an “unilluminated state” (thereby conserving energy), till the vehicle 202 reaches the charging stations 116b, 116g or till a predefined time duration before the vehicle 202 reaches the charging stations 116b, 116g (as determined via the real-time vehicle 202 geolocation).

In further aspects, in addition to determining the optimal charging stations for the vehicle 202 to charge during the trip as described above, the processor 124 may determine an optimal amount of energy to be transferred to the vehicle 202 at each charging station 116b, 116g based on the charging station information, the vehicle 202 information, the user's planned departure time, the user's planned arrival time, and the real-time vehicle 202 geolocation. In some aspects, the processor 124 may determine the optimal amount of energy such that the vehicle 202 is not required to stay for too long at the charging station 116b, 116g or unnecessarily charge above a required limit for the trip, while at the same time ensuring that the vehicle 202 has enough state of charge (SOC) level for the vehicle 202 to conveniently travel from the trip source location 104 to the trip destination location 106. The processor 124 may also factor-in per-unit energy pricing at each charging station, emission rate at each charging station, availability of fast chargers at each charging station, wear and tear information at each charging station, and/or the like, while determining the optimal amount of energy, so that the user 102 is not economically inconvenienced while charging the amount of energy.

Responsive to determining the optimal amount of energy as described above, the processor 124 may transmit, via the transceiver 122, information associated with the optimal amount of energy to the vehicle 202 and/or the computing systems associated with the charging stations 116b, 116g, so that the vehicle 202 and/or the computing systems may enable the optimal amount of energy to be transferred to the vehicle 202 when the vehicle 202 connects to the charger at the charging station 116b or 116g.

Further, as described above, the processor 124 monitors the real-time vehicle 202 geolocation as the vehicle 202 travels between the trip source location 104 and the trip destination location 106. In some aspects, the processor 124 may predict an estimated time of arrival for the user 102/vehicle 202 at the trip destination location 106 based on the real-time vehicle 202 geolocation. Responsive to predicting the estimated time of arrival for the user 102/vehicle 202 at the trip destination location 106, the processor 124 may transmit, via the transceiver 122, an information associated with the estimated time of arrival to the computing device associated with the trip destination location 106. In some aspects, the trip destination location 106 may be a house, an office or a hotel.

Responsive to receiving the information associated with the estimated time of arrival, the computing device (e.g., the hotel computing device) may control operations of or activate one or more user comfort devices at the trip destination location 106/hotel based on the information associated with the estimated time of arrival. In an exemplary aspect, when the trip destination location 106 is a hotel, the user comfort devices may be one or more of a heating, ventilation, and air conditioning (HVAC) system, a light, a television, an electronic equipment, and/or the like located at a room associated with/booked by/allocated to the user 102. In some aspects, the computing device may control the operations of the comfort devices by activating the comfort devices based on the estimated time of arrival and may not activate the comfort devices well before the user's estimated time of arrival. For example, if the estimated time of arrival is 7 PM, the computing device may activate the HVAC system by 6:30 PM and not before (or may not keep the HVAC system ON throughout the day), thereby ensuring that energy is not unnecessarily consumed in the room (e.g., for operating the HVAC system) at those times when the user 102 is not expected to be in the room.

In further aspects, when the user 102 arrives at the trip destination location 106/hotel, the processor 124 may determine optimal charging time durations when the vehicle 202 may charge at the hotel and optimal discharging time durations when the vehicle 202 may transfer energy to the grid via the hotel. In some aspects, the processor 124 may determine those time durations as the optimal charging time durations when the per-unit energy pricing may be low and/or the emission rate associated with vehicle charging is expected to be low. Further, the processor 124 may determine those time durations as the optimal discharging time durations when the per-unit energy pricing may be high and/or the emission rate associated with vehicle charging is expected to be high. The processor 124 may transmit, via the transceiver 122, information associated with the determined optimal charging and discharging time durations to the vehicle 202, so that the vehicle 202 may accordingly charge and discharge at the hotel. In this manner, the processor 124 facilitates the vehicle 202 in optimizing energy consumption when the vehicle 202 may be located/parked at the hotel (e.g., during overnight stay at the hotel).

Although the description above describes an aspect where the user 102 declines the request (transmitted by the processor 124) to travel on the trip by using the train 108 and the vehicle 110, the present disclosure is not limited to such an aspect. In some aspects, when the user 102 accepts to travel on the trip by using the train 108 and the vehicle 110 (i.e., the scenario 100 shown in FIG. 1), the user 102 may transmit, via the user device 112 (or the vehicle 202), a user confirmation on the request to the system 114/transceiver 122. The processor 124 may obtain the user confirmation from the transceiver 122 and may transmit, via the transceiver 122, a signal to the server 118 to reserve a sitting area for the user 102 on the train 108 and the vehicle 110. The processor 124 may further transmit, via the transceiver 122, a reservation confirmation message (including the reservation tickets) to the user device 112 (or the vehicle 202), responsive to transmitting the signal to the server 118 or responsive to the server 118 booking the sitting area/tickets for the user 102.

In this case, when the user 102 boards the train 108, the processor 124 may start to track a real-time train movement or train arrival status at the intermediary trip location 120 (based on inputs obtained from the server 118). The processor 124 may further estimate an expected time of vehicle 110 travel commencement from the intermediary trip location 120 to the trip destination location 106 based on the user's planned departure time from the trip source location 104 (or user's train boarding time) and the train's arrival status at the intermediary trip location 120. The processor 124 may further transmit a command signal to the vehicle 110 a predefined time duration before the expected time of vehicle 110 travel commencement to pre-condition the vehicle 110. The concept of pre-conditioning a vehicle is already described above. In this case, pre-conditioning the vehicle 110 may include controlling vehicle 110 battery temperature and heating or cooling handlebars, sitting area (that may be used by/booked for the user 102), activating electronic displays, etc.

In further aspects, the processor 124 may transmit, via the transceiver 122, a real-time vehicle 110 status (e.g., whether the vehicle 110 is already parked at the intermediary trip location 120 or about to reach, vehicle health data, etc.) to the user device 112 when the user 102 may be traveling on the train 108, so that the user 102 may be aware of the vehicle 110 status. In some aspects, the vehicle 110 may also self-drive to a pick-up location at the intermediary trip location 120, when the user 102/train 108 reaches the intermediary trip location 120.

The processor 124 may further perform actions associated with the vehicle 110 in the same manner as the operations described above for the vehicle 202. For example, the processor 124 may determine optimal charging stations for the vehicle 110 to charge between the intermediary trip location 120 and the trip destination location 106 in the similar manner as the processor 124 determines the optimal charging stations for the vehicle 202. Further, the processor 124 may determine an optimal amount of energy to be transferred to the vehicle 110 at the charging station during each charging event in the same manner as described above. Furthermore, the processor 124 may transmit the information associated with the estimated time of arrival via the vehicle 110 to the computing device associated with the hotel in the similar manner as described above, so that the hotel may optimize energy consumption at the hotel room booked for the user 102.

In some aspects, the system 114 may follow a similar (but reverse) process when the user 102 travels back from the trip destination location 106 (e.g., the hotel) to the trip source location 104 (e.g., the user's house).

The vehicles 110, 202, the system 114 and/or the user 102 implement and/or perform operations, as described here in the present disclosure, in accordance with the owner manual and safety guidelines. In addition, any action taken by the user 102 based on the notifications/recommendations provided by the system 114 should comply with all the rules specific to the location and operation of the vehicles 110, 202 (e.g., Federal, state, country, city, etc.). The notifications/recommendations, as provided by the system 114, should be treated as suggestions and only followed according to any rules specific to the location and operation of the vehicles 110, 202.

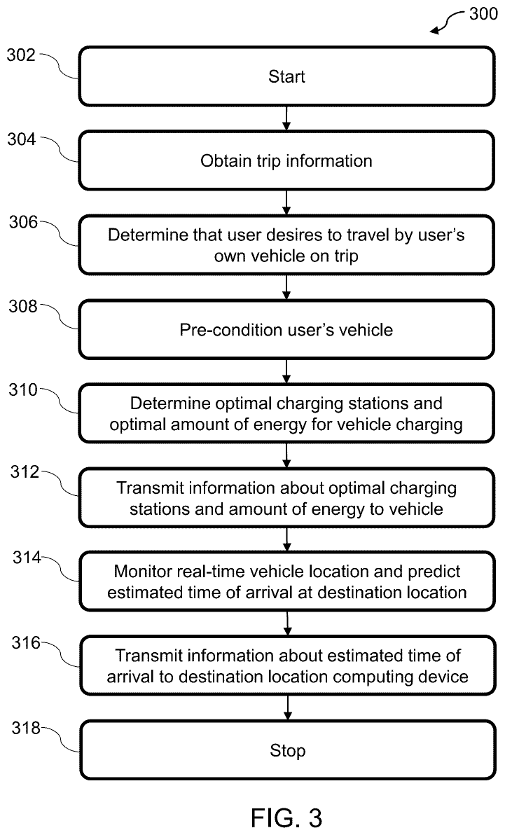

FIG. 3 depicts a flow diagram of an example first road trip planning method 300 in accordance with the present disclosure. FIG. 3 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 300 starts at step 302. At step 304, the method 300 may include obtaining, by the processor 124, the trip information. At step 306, the method 300 may include determining, by the processor 124, that the user 102 desires to travel on the trip by using the user's own vehicle 202. At step 308, the method 300 may include causing to pre-condition, by the processor 124, the vehicle 202.

At step 310, the method 300 may include determining, by the processor 124, the optimal charging stations 116b, 116g for the vehicle 202 to charge on the trip and the optimal amount of energy for vehicle 202 charging. At step 312, the method 300 may include transmitting, by the processor 124, information associated with the charging stations 116b, 116g (e.g., their location information) and the amount of energy to the vehicle 202 and/or the computing systems associated with the charging stations 116b, 116g.

At step 314, the method 300 may include monitoring, by the processor 124, the real-time vehicle 202 geolocation and predicting the estimated time of arrival at the trip destination location 106 based on the real-time vehicle 202 geolocation. At step 316, the method 300 may include transmitting, by the processor 124, information associated with the estimated time of arrival to the destination location computing device, which may control operation of one or more comfort devices for the user 102 at the trip destination location 106 based on the estimated time of arrival, as described above.

At step 318, the method 300 may end.

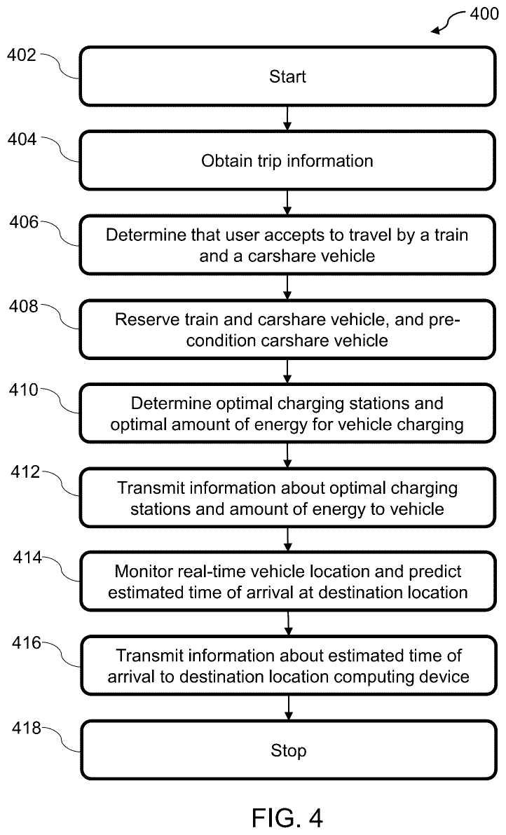

FIG. 4 depicts a flow diagram of an example second road trip planning method 400 in accordance with the present disclosure. FIG. 4 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 400 starts at step 402. At step 404, the method 400 may include obtaining, by the processor 124, the trip information. At step 406, the method 400 may include determining, by the processor 124, that the user 102 accepts to travel by the train 108 and a carshare vehicle (e.g., the vehicle 110). At step 408, the method 400 may include reserving, by the processor 124, the train 108 and the vehicle 110 for the user 102 and causing to pre-condition the vehicle 110.

Steps 410, 412, 414 and 416 may be same as the steps 310, 312, 314 and 316 described above; however, the steps 410, 412, 414 and 416 may be performed by the processor 124 for the vehicle 110 (as opposed to the vehicle 202). Since the steps 310-316 are same as the steps 410-416, the steps 310-316 are not described again here for the sake of simplicity and conciseness.

The method 400 may end at step 418.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A road trip planning system comprising:
a transceiver configured to receive a trip information associated with a user, wherein the trip information comprises information associated with a trip source location and a trip destination location; and
a processor communicatively coupled with the transceiver, wherein the processor is configured to:
determine that the user is traveling via a first vehicle between the trip source location and the trip destination location;
monitor a real-time first vehicle geolocation associated with the first vehicle when the first vehicle is traveling between the trip source location and the trip destination location;
predict an estimated time of arrival for the user at the trip destination location based on the real-time first vehicle geolocation; and
transmit an information associated with the estimated time of arrival to a computing device associated with the trip destination location, wherein the computing device activates one or more user comfort devices at the trip destination location based on the information associated with the estimated time of arrival.

2. The road trip planning system of claim 1, wherein the trip information further comprises information associated with a planned departure time from the trip source location and a planned arrival time at the trip destination location.

3. The road trip planning system of claim 2, wherein the first vehicle is an Electric Vehicle (EV).

4. The road trip planning system of claim 3, wherein the processor is further configured to:
estimate an expected time of first vehicle travel commencement between the trip source location and the trip destination location based on the planned departure time; and
transmit a command signal to the first vehicle to cause a first vehicle pre-conditioning at a predefined time duration before the expected time, wherein the first vehicle pre-conditioning comprises controlling at least one of a first vehicle battery temperature, a first vehicle cabin temperature, a first vehicle steering wheel temperature or a first vehicle sitting area temperature.

5. The road trip planning system of claim 3, wherein the processor is further configured to:
obtain a charging station information associated with a plurality of charging stations located between the trip source location and the trip destination location;
obtain a first vehicle information associated with the first vehicle;
determine one or more optimal charging stations, from the plurality of charging stations, for the first vehicle to charge, based on the charging station information, the first vehicle information, the planned departure time, the planned arrival time, and the real-time first vehicle geolocation; and
transmit a location information associated with the one or more optimal charging stations to the first vehicle or a user device associated with the user.

6. The road trip planning system of claim 5, wherein the processor is further configured to transmit the real-time first vehicle geolocation to computing systems associated with the one or more optimal charging stations, and wherein the computing systems are configured to control operating conditions of one or more chargers at the one or more optimal charging stations based on the real-time first vehicle geolocation.

7. The road trip planning system of claim 5, wherein the processor is further configured to:
determine an optimal amount of energy to be transferred to the first vehicle at each charging station of the one or more optimal charging stations based on the charging station information, the first vehicle information, the planned departure time, the planned arrival time, and the real-time first vehicle geolocation; and
transmit information associated with the optimal amount of energy to at least one of the first vehicle or computing systems associated with the one or more optimal charging stations.

8. The road trip planning system of claim 5, wherein the charging station information comprises at least one of an expected emission rate associated with each charging station for different times of a day, an expected per unit energy price at each charging station for different times of a day, wear and tear information associated with one or more components of each charging station, or an energy output capacity information associated with each charger of each charging station.

9. The road trip planning system of claim 5, wherein the first vehicle information comprises at least one of an energy receiving capacity information associated with the first vehicle, or a wear and tear information associated with one or more components of the first vehicle.

10. The road trip planning system of claim 1, wherein the transceiver receives the trip information from a user device associated with the user or a server.

11. The road trip planning system of claim 1, wherein the processor determines that the user is traveling via the first vehicle based on user inputs obtained from a user device associated with the user or inputs obtained from the first vehicle.

12. The road trip planning system of claim 1, wherein the trip destination location is a house, an office or a hotel, and wherein the one or more user comfort devices comprises at least one of a heating, ventilation, and air conditioning (HVAC) system, a light, a television, or electric equipment located at a room associated with the user.

13. The road trip planning system of claim 1, wherein the processor is further configured to:
determine that a second vehicle is available to travel on a trip portion between the trip source location and the trip destination location and the first vehicle is configured to travel a remaining trip portion between the trip source location and the trip destination location;
transmit a request to a user device associated with the user to travel between the trip source location and the trip destination location by using the second vehicle for the trip portion and the first vehicle for the remaining trip portion;
obtain a user confirmation responsive to transmitting the request;
transmit a signal to a server to reserve the second vehicle and the first vehicle for the user; and
transmit a reservation confirmation message to the user device, responsive to transmitting the signal to the server.

14. The road trip planning system of claim 13, wherein the second vehicle is a train.

15. A road trip planning method comprising:
determining, by a processor, that a user is traveling via a vehicle between a trip source location and a trip destination location;
monitoring, by the processor, a real-time vehicle geolocation associated with the vehicle when the vehicle is traveling between the trip source location and the trip destination location;
predicting, by the processor, an estimated time of arrival for the user at the trip destination location based on the real-time vehicle geolocation; and
transmitting, by the processor, an information associated with the estimated time of arrival to a computing device associated with the trip destination location, wherein the computing device activates one or more user comfort devices at the trip destination location based on the information associated with the estimated time of arrival.

16. The road trip planning method of claim 15, wherein the vehicle is an Electric Vehicle (EV).

17. The road trip planning method of claim 16 further comprising:
estimating an expected time of vehicle travel commencement between the trip source location and the trip destination location based on a planned departure time from the trip source location; and
transmitting a command signal to the vehicle to cause a vehicle pre-conditioning at a predefined time duration before the expected time, wherein the vehicle pre-conditioning comprises controlling at least one of a vehicle battery temperature, a vehicle cabin temperature, a vehicle steering wheel temperature or a vehicle sitting area temperature.

18. The road trip planning method of claim 15, wherein the trip destination location is a house, an office or a hotel, and wherein the one or more user comfort devices comprises at least one of a heating, ventilation, and air conditioning (HVAC) system, a light, a television, or electric equipment located at a room associated with the user.

19. The road trip planning method of claim 15 further comprising:
obtaining a charging station information associated with a plurality of charging stations located between the trip source location and the trip destination location;
obtaining a vehicle information associated with the vehicle;
determining one or more optimal charging stations, from the plurality of charging stations, for the vehicle to charge, based on the charging station information, the vehicle information, a planned departure time from the trip source location, a planned arrival time at the trip destination location, and the real-time vehicle geolocation; and
transmitting a location information associated with the one or more optimal charging stations to the vehicle or a user device associated with the user.

20. A non-transitory computer-readable storage medium having instructions stored thereupon which, when executed by a processor, cause the processor to:
determine that a user is traveling via a vehicle between a trip source location and a trip destination location;
monitor a real-time vehicle geolocation associated with the vehicle when the vehicle is traveling between the trip source location and the trip destination location;
predict an estimated time of arrival for the user at the trip destination location based on the real-time vehicle geolocation; and
transmit an information associated with the estimated time of arrival to a computing device associated with the trip destination location, wherein the computing device activates one or more user comfort devices at the trip destination location based on the information associated with the estimated time of arrival.
